(19) United States
(12) Patent Application Publication
(10) Pub. No.: US 2003/0080563 A1
(43) Pub. Date: May 1, 2003

(54) Irrigation valve

(76) Inventors: Dennis Roberts, Peoria, IL (US); Robert Nytko, Washington, IL (US); Dale Hansen, East Peoria, IL (US)

Correspondence Address: Daniel H. Shulman, Mayer, Brown, Rowe & Maw, P.O. Box 2828, Chicago, IL, 60690-2828, US

(21) Appl. No.: 10/279,711

(22) Filed: Oct. 24, 2002

Related U.S. Application Data
(62) Division of application No. 09/709,053, filed on Nov. 10, 2000, now abandoned.
Application No. 09/709,053 is a continuation-in-part of application No. 09/511,721, filed on Feb. 21, 2000, now abandoned.

(51) Int. Cl. F16L 33/18

(52) U.S. Cl. 285/354; 285/360; 285/401; 285/376

(57) ABSTRACT

Disclosed herein is an improved system and method for connecting a first piece of plumbing, such as but not limited to a valve, to a second piece of plumbing. The first piece of plumbing has a male threaded fitting formed about an opening. The second piece of plumbing has an open end with a connecting member attached. The connecting member has a flange, and behind the flange is a flange nut having female threading extending over the flange. The pieces of plumbing are connected as the flange nut screwably engages the male threaded fitting.

### BACKGROUND OF THE INVENTION

1. Field of the Invention

The present invention relates to a system for connecting plumbing. Particularly, the present invention is directed to a system for connecting pieces of plumbing having different diameters wherein the connected pieces can still be easily disengaged. More particularly, the invention relates to a system for connecting a valve having a male threaded union fitting to plumbing having the same or different diameter.

2. Description of Related Art

The use of valves in plumbing systems of all types is well known in the art. Prior valves have been produced having inlet and outlet ports having interior female threading for connection to a male threaded pipe. The valve is connected by placing the end of the male threaded pipe into the port and screwing the valve onto the pipe.

There are several disadvantages to this prior connection system. First, a worker must go to a work site laden with pipes and valves of different diameters to ensure that the plumbing installed fits the plumbing to be connected. Often, for example, a worker will bring a two inch valve to a job only to find that the plumbing system is comprised of one and a half inch pipe. The differing diameters of the pipe and valve openings makes connection impossible without additional fitting and labor to install. Another disadvantage is that even if the valve and pipe can-be screwably mated, the seal created by this simple threaded connection is prone to deteriorate through corrosion, stripping or dirt. Hence a worker typically must tape the connection with an impermeable tape, adding cost, time and effort to the job.

Yet another significant disadvantage of the prior connection system is that removal of the valve is often difficult. Because a valve may have a non-symmetrical shape, it is often difficult to rotate the valve to unscrew the connection. If the plumbing system is placed in the ground, a worker may have to dig a trough beneath the valve to allow the valve to rotate. Further, if the valve is connected at another end, especially if the valve has other openings at some angle to the first connection, rotation of the valve is impossible without disassembling significant parts of the plumbing system. The same problem arises if an angled pipe is connected instead of a valve.

It is known in the art to provide a union fitting for the valve to create a male threaded extension. The union fitting in the prior art typically has a male threaded end to be screwed into the female threaded opening of the valve, and another male threaded end to be screwably attached to a nut positioned behind a flange attached to a piece of pipe to be connected.

This configuration, however, suffers the same disadvantage as the simpler male pipe into port connection. To remove the valve from the union fitting, the valve still must be rotated and unscrewed. A second problem is that a worker must still carry multiple union fittings to attach the valve to different sized pipes, or different valves to attach to a single provided union fitting. Moreover, the problem of the weaker seal between the valve and the union fitting is still not addressed.

In addition, prior union fittings were not suitable for use with all valves. For example, PVC irrigation valves coupled with PVC union fittings could not withstand the high burst pressures experienced at the abutment of the union fitting and the face of the flange attached to the pipe being connected. Moreover, the PVC union fittings cannot be solvently welded to other, more resilient materials.

Additionally, it is expensive to utilize separate union fittings and separate valves each time a different size pipe is encountered. Because a worker might encounter different types of pipes on a single job or in a single pipeline system, the prior art system of providing separate union fittings had only limited applications.

A need exists in the art, for a system for connecting pieces of plumbing wherein the connected pieces may be easily removed. The system should be suitable for use with plumbing pieces of any type, including but not limited to pipes, valves, spigots, faucets or other gas or fluid carriers known in the art.

A further need exists in the art for a system to connect pieces of plumbing having ends with differing diameters. The needed system would connect a valve to a pipe having a diameter less than, equal to, or greater than the diameter of the valve opening.

A further need exists in the art to provide a system for connecting plumbing which would provide an improved seal between pieces of plumbing to be connected.

A further need exists in the art for a valve and union fitting that can withstand the burst pressures of union fitting connections.

There thus remains a need for an efficient and economic method and system for connecting a valve to a pipe that overcomes the disadvantages of the prior art.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof, as well as from the appended drawings.

A feature of an embodiment of the present invention is a valve having an integral male-threaded union fitting, wherein the valve body and male-threaded fitting are made of glass-filled nylon. A further feature of an embodiment of the invention is a union fitting wherein the male-threaded fitting is made of glass-filled nylon. An advantage of these embodiments of the invention is that a union fitting that can withstand high burst pressures is achieved.

Another feature of an embodiment of the present invention is a valve having only male threaded ports. An advantage of this embodiment of the present invention is that it is no longer necessary to carry numerous separate union fittings.

A feature of the present invention is a male threaded union fitting at the end of the first piece of plumbing to be connected. Another feature of the present invention is a connecting member having a flange and flange nut about the circumference of the second piece of plumbing to be connected. An advantage of the present invention is that the nut may screwably engage a first piece of plumbing adjacent the flange, pressing the flange to the first piece of plumbing and hence connecting the two pieces. Another advantage of the present invention is that the two pieces to be connected do not have to be screwed to each other. The advantage of the configuration of the present invention is that the pieces of plumbing may be easily removed by screwing back the nut and lifting the first piece of plumbing out of the system. Yet another advantage of the present invention is that, when the first piece of plumbing is a valve, the valve does not have to be rotated to be removed from the plumbing system. Rather, the flange nut may be screwed back from the valve's male threaded fitting and the valve may be lifted out of the system for easy service or replacement.

A feature of the present invention is a male threaded union fitting about the larger opening. Yet another feature of the present invention is a connecting member to fit over the smaller piece of plumbing. Yet another feature of the present invention is a flange on the connecting member having a circumference equal to the circumference of the male threaded fitting. Another feature of the present invention is a nut situated behind the flange having female threading extending over the flange. Another possible feature of the present invention is a bayonet type attachment in-place of threads comprising a flange about the union fitting, said flange having on opening thereon and interlocking notches to at least one side of the opening, and a protrusion on the inner surface of the connecting member to fit through the opening and lock behind the flange upon rotation. An advantage of the present invention is that the nut may screwably or rotatably engage the larger piece of plumbing. Yet another advantage of the present invention is that workers need not carry extra plumbing to attempt to precisely match the sizes of pieces to be connected. Yet another advantage of the present invention is that workers may carry a single size valve that, through use of different size connecting members, may be connected to any size pipe. A further advantage of the present invention is lower labor and parts costs for a particular job. A further advantage of the present invention is that fluid dynamics are improved by using a larger valve with a smaller connection.

A possible feature of the present invention is the provision of an o-ring between the flange and the male threaded opening of the piece of plumbing to which it is to be connected. A further possible feature is a rubber face fixed to the face of the flange at the point of contact with the piece of plumbing to be connected. An advantage of the present invention is that a compression seal, as is created with a rubber face, o-ring or gasket, provides a better seal than a simple threaded connection which may leak if the threads are not precisely matched. Hence, simple threaded seals may deteriorate as threading corrodes or becomes stripped. Further, threaded seals usually must be wrapped in an impermeable tape to ensure sealing. An advantage of the present invention is that leakage is prevented without the use of tape.

In brief, the invention includes a system for connecting a first piece of plumbing to a second piece of plumbing comprising: a first piece of plumbing having a glass-filled nylon fitting formed about an opening; a second piece of plumbing having an open end; a connecting member attached to said open end of said second piece of plumbing, said connecting member having a flange; and a flange nut partially behind said flange and having an extension over said flange, wherein said flange nut engages said fitting.

The invention also includes the system wherein said fitting includes a male threading on its exterior, and said flange nut extension has a female threading, and said flange nut screwably engages said male threaded fitting.

The invention also includes the system wherein said fitting includes a fitting flange about the face of said fitting, said fitting flange having at least one opening thereon, and said flange nut extension includes a protrusion extending radially therefrom, said protrusion adapted to fit through said flange opening, wherein said flange nut rotatably engages said fitting. The invention also further comprises interlocking notches at the rear of said fitting flange, said notches to lock said protrusion upon rotation of said flange nut.

The invention also includes a method for connecting a valve having a glass-filled nylon fitting to a pipe comprising: a step for attaching a connecting member to said pipe, said connecting member comprising a hollow body and a flange; placing a flange nut partially behind said flange, said flange nut having an extension over said flange; placing said fitting of said valve adjacent said flange; and a step for attaching said flange nut to said fitting.

The invention also includes an irrigation valve comprising a body, an inlet port and at least one outlet port, and a male-threaded fitting integrally formed about the circumference of the at least one outlet port, wherein the valve and fitting are made of glass-filled nylon.

It is to be understood that both the foregoing general description and the following detailed description are exemplary and are intended to provide further explanation of the invention claimed.

The accompanying drawings, which are incorporated in and constitutes part of this specification, are included to illustrate and provide a further understanding of the method and system of the invention. Together with the description, the drawings serve to explain the principles of the invention.

### BRIEF DESCRIPTION OF THE DRAWINGS

FIG. 1 is an exploded elevated side view of a connector according to the present invention.

FIG. 2 is an elevated perspective view of a connector according to the present invention.

FIG. 2A is an elevated end view of a flange nut according to the present invention.

FIG. 3 is an elevated view of the connecting member of the present invention.

FIG. 4 is an exploded elevated side view of an alternative embodiment of a connector according to the present invention.

FIG. 5 is an elevated perspective view of an alternative embodiment of a connector according to the present invention.

### DETAILED DESCRIPTION OF THE PREFERRED EMBODIMENT

Reference will now be made in detail to the present preferred embodiments of the invention, examples of which are illustrated in the accompanying drawings. The invention will be described in conjunction with the detailed description of the system in which like numerals represent like elements throughout.

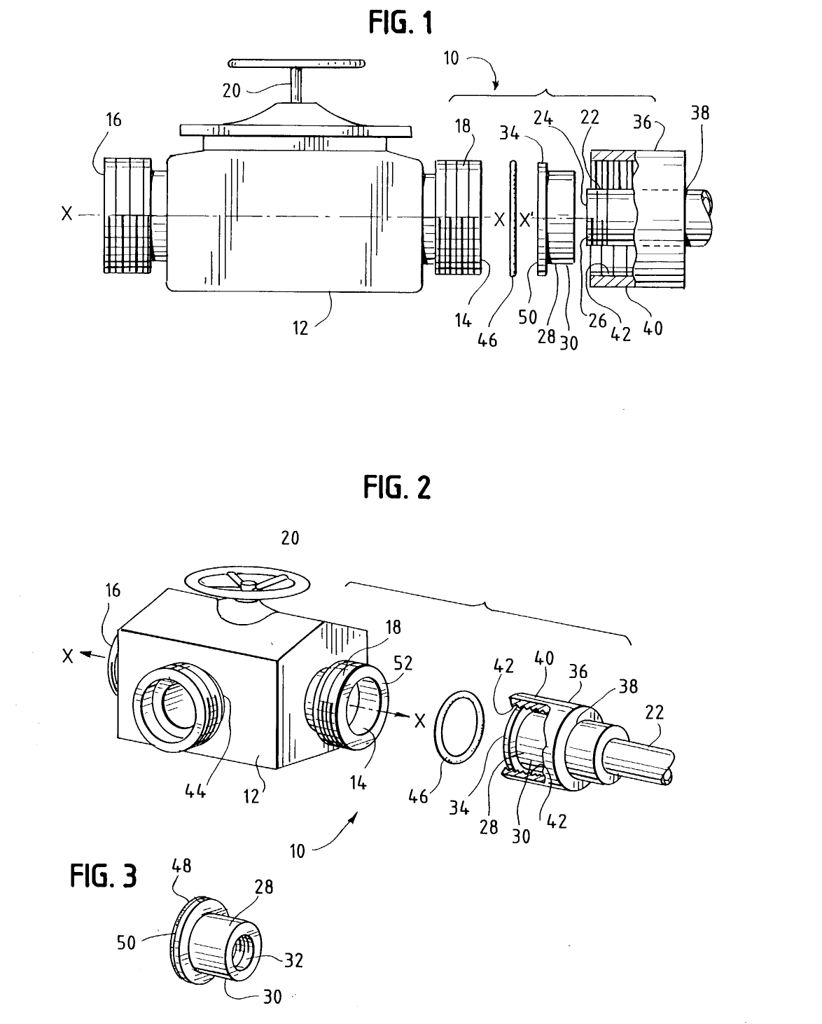

An embodiment of the present invention, designated generally at numeral 10, is disclosed in FIG. 1. As shown in one embodiment, a first piece of plumbing, such as a valve 12 is provided having two openings 14 and 16, extending outward from the valve 12, to be used, for example, as input or output ports of the valve 12. The valve 12 can be made of any plastic or metal material, or other resilient material such as, without limitation, brass, brass alloys, nylon, nylon base filled material such as but not limited to glass-filled nylon and mineral filled nylon, PVC and PVC base filled material such as but not limited to glass or mineral filled. It is intended that the valve 12 be suitable for any type of plumbing system for which a valve may be used, including but not limited to irrigation systems, water pipeline systems, or any other plumbing system for which a valve is utilized. The instant valve 12 has a male threading 18 about the openings 14 and 16. The threading 18 is integrally formed around the openings 14 and 16 in a manner well known in the art. In the preferred embodiment, both the valve 12 and threading 18 are made of a resilient material such as, without limitation, glass-filled nylon and the like. The valve 12 may also have a handle 20 for altering the output of the valve 12. In the present embodiment, the handle 20 is disposed on top of the valve 12. It should be understood that the present invention includes within its scope valves of any shape or type, including without limitation, ball valves, sequencing valves or irrigation valves, with or without handles protruding from any point on the valve body.

The present system further has a second piece of plumbing, such as a pipe 22 to be connected to a first piece of plumbing, such as the valve 12. The pipe 22 has an open end 24 to mate with the valve 12, and a second open end (not shown) connected to another piece of plumbing, input source or output drain. The pipe 22 typically, although not necessarily, has male threading 26 about the circumference of the end 24 for screwable mating with another piece of plumbing, such as another pipe or a valve. Other pipes without threaded ends may be utilized, however, and such pipes are typically attached to joints or fittings via solvent welding. In addition, pipes 22 may be attached to a fitting via friction fit, sonic welding, glue fit, poly-pipe fit, slip fit, or other methods known and understood in the art.

Prior to the present invention, the pipe 22 would be connected directly to an opening of a valve having a female threading. Alternatively, the end 24 of the pipe 22 could be attached to a threaded adapter via a frictional fit, solvent welding, friction fit, sonic welding, glue fit, poly-pipe fit, slip fit, or other methods known and understood in the art. In this arrangement, differing diameters of pipe and valve openings would require the worker to have ready an inventory of valves or pipes adapted to match the plumbing he might encounter. For example, a worker might encounter a valve having a two inch opening but have only one and a half inch pipe at his disposal. Because of the differing diameters, the plumbing could not be screwably mated. In addition, where the valve has a glass-filled nylon body, solvent welding or glueing to a PVC pipe is impossible. Moreover, threaded connections between PVC pipe and glass-filled nylon are not recommended since glass-filled nylon and PVC react differently to pressure and heat. Hence, a threaded PVC to glass-filled nylon connection may relax under the high pressures of typical glass-filled nylon valves, causing leakage or catastrophic failure of the connection. The present system overcomes the disadvantage of the prior art by providing a glass-filled nylon male threaded fitting, about the opening 14 of the valve 12 and attaching a connecting member 28 to the end 24 of the pipe 22. By utilizing a union fitting according to this embodiment, the structural advantages of glass-filled nylon are achieved without foregoing the commonly encountered PVC pipes.

Referring now to FIGS. 1-3, the connecting member 28 has a hollow body 30 made of resilient material such as, without limitation, brass, brass alloys, nylon, nylon base filled material such as but not limited to glass-filled nylon and mineral filled nylon, PVC and PVC base filled material such as but not limited to glass or mineral filled formed by processes well known in the art. The hollow body 30 has a first end to be attached to the pipe 22, and a second end to be placed adjacent the opening 14 of the valve 12. The hollow body 30 may have female threading 32 with which to screwably attach to the end 24 of the pipe 22. It is to be understood that other means for attaching the connecting member 28 to the pipe 22 may be utilized, such as a frictional fit, poly-pipe fit, slip fit, interlocking notches, solvent welding with a glue, or integrally forming or sonically welding the pipe 22 with the connecting member 28 at the end 24. The connecting member 28 further includes a flange 34 about the first end of the hollow body 30 extending radially from the hollow body 30. The flange 34 may also include male threading aroung its outer edge.

In the preferred embodiment, the flange 34 has an outer diameter less than the minor diameter of the male threading 18 about the opening 14 of the valve 12. The hollow body 30 is then manufactured to have a width equal to that of the pipe 22 to be connected. Hence, a worker need only choose a suitable connecting member 28 to connect pipes and valves having differing diameters. A worker, therefore, need only carry different connecting members 28 to a job rather than an inventory of valves or pipes. This decreases the workload of the worker and decreases the cost of inventory as the connecting members 28 may be cheaply produced. In one embodiment common in the irrigation industry, a connecting member 28 would be provided having a large enough flange 34 and a one and a half inch hollow body 30 to connect a valve with a two-inch opening to a one and a half inch pipe. It should be apparent, though, that the present system is intended to connect plumbing of any size, same or different.

Referring again to FIGS. 1 and 2, the present system further includes a flange nut 36 (cross-sectional view shown in FIG. 1) positioned partially behind the flange 34 of the connecting member 28. The flange nut 36 has an opening 38 having an inner diameter slightly larger than that of the hollow body 30 of the connecting member 28 to allow the flange nut 36 to encircle the hollow body 30, but smaller than the outer diameter of the flange 34 so that the flange nut 36 is prevented from translating forward of the flange 34, while the extension 40 is permitted to translate forward of the flange 34. The flange nut 36 further includes an extension 40, preferably around the entire circumference of the flange nut 36. In FIG. 1, the flange nut 36 is depicted in cross section to show the extension 40, although it is intended in the preferred embodiment that the extension 40 be formed around the entire circumference of the flange nut 36. Alternative flange nuts 36 may also be suitable for the present invention, including flange nuts and extensions that only partially encircle the hollow body 30. In FIG. 2, the extension 40 is shown with a portion cut away to show that the extension 40 completely encircles the circumference of the flange nut 36. However, the extension 40 need not completely encircle the circumference of the flange nut 36. In the preferred embodiment, the flange nut 36 has a generally cylindrical shape. Of course, the flange nut 36 may be produced having any shape adapted to fit over the connecting member 28, including with exterior protrusions, handles, extensions, moldings or ribbing for easier gripping and manipulation, and all such embodiments are to be considered within the scope of the present invention.

The extension 40 has a female threading 42 all about its interior. Other suitable extensions 40 may only include a portion of female threading, without departing from the scope of the invention. In operation, the connecting member 28 is attached to a pipe 22 in a manner described above or known in the art. The flange 34 of the connecting member 28 is placed adjacent the opening 14 of the valve 12 such that the axis x of the valve 12 and the axis x′ of the pipe 22 are aligned. The flange nut 36 is fitted over the hollow body 30 such that the female threading 42 on the extension 40 may screwably engage the male threading 18 about the opening 14 of the valve 12. As the flange nut 36 is rotated, the opening 14 is pressed against the flange 34, and the pipe 22 and the valve 12 are connected.

The advantages of the present system for connecting the plumbing are now apparent. In the prior art, to connect or disconnect the valve 12, the valve would have to be rotated about the axis x to screw or unscrew a female threaded opening and the end 24 of the pipe 22. Where the valve 12 is buried, or where the valve has an irregular shape, as for example may be produced by a handle 20, rotation of the valve 12 about the axis x is difficult if not impossible. Moreover, if, as in FIG. 2, the valve 12 has a third opening 44, or any number of additional openings, and that opening 44 is connected to another pipe, it may be impossible to rotate and remove the valve 12 without deconstructing large parts of the plumbing system.

In the present system, the valve 12 with the male threaded fitting 18 is easily removed by unscrewing the flange nut 36 and lifting the valve 12 directly out of the plumbing system. Hence, little effort and virtually no deconstruction of other parts of the plumbing system is required to remove the valve 12.

Another aspect of the present invention is inclusion of an improved means for preventing leakage between the valve 12 and the plumbing system. In the present invention, two leakage prevention means are disclosed. In FIGS. 1 and 2, the leakage prevention means is an O-ring 46 placed between the flange 34 and the opening 14. The O-ring 46 can be made of rubber or any other suitable sealing or gasket material known in the art. For example, the seal material may also include a compound applied between the two mating surfaces, such as silicon rubber or other compressible material. In FIG. 3, the leakage prevention means is a ring 48 fixed to the outer surface 50 of the flange 34. A ring may also be affixed to the outer face 52 of the opening 14. The ring 48 can be made of any materials known in the art for providing a seal, and can be fixed by many different methods known in the art. The leakage prevention means may also include a gasket.

In either embodiment, as the flange nut 36 screwably engages the male threading 18, the leakage prevention means is compressed between the outer surface 50 of the flange 34 and the outer face 52 of the opening 14. This compression seal is an improvement over a simple threaded attachment, as is used in the prior art. First, the threading must precisely match to create a seal; any out of round or stripped threading will destroy the integrity of the seal. Additionally, the seal of the prior art becomes less effective as wear and tear and corrosion affect the plumbing. Finally, it is common in the art to have to use an impermeable tape to wrap the seal and prevent leakage. The present system provides a seal that remains strong over time and does not require taping to prevent leakage.

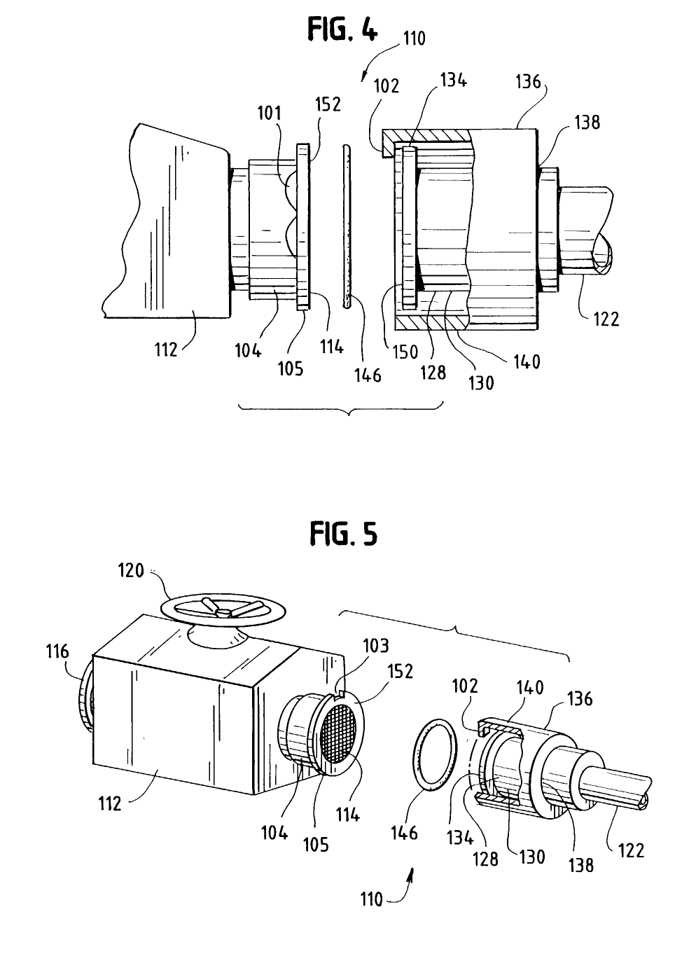

FIGS. 4 and 5 depict another embodiment of the present invention, depicted generally as numeral 110. In FIGS. 4 and 5, the union fitting 104 comprises a flange 105 extending radially about the face 152 of the fitting. The flange 105 has at least one opening 103 thereon. The flange nut 136 of the present embodiment comprises an axial extension 140 having at least one protrusion 102 protruding radially from the distal end of said extension 140. The protrusion 102 has a width slightly less than the opening 103 so that the protrusion will fit through the opening 103 when the flange nut 136 engages the union fitting 104. The protrusion 102 should extend radially to match approximately the length of the flange 105. Ideally, although not necessarily, the number of protrusions 102 is equal to the number of openings 103.

The union fitting 104 further includes a pair of interlocking notches 101 extending axially from the rear side of the flange 105. Preferably, although not necessarily, the pair of notches 101 are disposed a quarter turn to one side of the opening 103. In addition, the number of pairs of notches 101 should match the number of openings 103. The notches 101 may be shaped hemispherically to interlock the protrusion 102. Alternatively, the notches 101 may be spring loaded wedges that may be pressed toward the flange 105 to allow the protrusion 102 to slide between them. Alternatively, the flange nut may include protrusions in its interior surface to engage notches or grooves on the exterior of the hollow body.

It will be apparent to those skilled in the art that various modifications and variations can be made in the system of the present invention without departing from the spirit or scope of the invention. Thus, it is intended that the present invention include modifications and variations that are within the scope of the appended claims and their equivalents.

What is claimed is:

1. A system for connecting a first piece of plumbing to a second piece of plumbing comprising:
a first piece of plumbing having a glass-filled nylon fitting formed about an opening;
a second piece of plumbing having an open end;
a connecting member attached to said open end of said second piece of plumbing, said connecting member having a flange; and
a flange nut partially behind said flange and having an extension over said flange, wherein said flange nut engages said fitting.

2. The system as recited in claim 1 wherein said fitting includes a male threading on its exterior, and said flange nut extension has a female threading, and said flange nut screwably engages said male threaded fitting.

3. The system as recited in claim 1 wherein said fitting includes a fitting flange about the face of said fitting, said fitting flange having at least one opening thereon, and said flange nut extension includes a protrusion extending radially therefrom, said protrusion adapted to fit through said flange opening, wherein said flange nut rotatably engages said fitting.

4. The system as recited in claim 3 further comprising interlocking notches at the rear of said fitting flange, said notches to lock said protrusion upon rotation of said flange nut.

5. The system as recited in claim 1 wherein said opening of said first piece of plumbing and said open end of said second piece of plumbing have different diameters.

6. The system as recited in claim 1 wherein said first piece of plumbing is a valve having a glass-filled nylon body.

7. The system as recited in claim 6 wherein said male fitting is integrally formed about said opening.

8. The system as recited in claim 1 further comprising a means for preventing leakage between said first piece of plumbing and said flange.

9. The system as recited in claim 8 wherein said leakage prevention means is an O-ring between said opening and said flange.

10. The system as recited in claim 8 wherein said flange has an outer surface and said leakage prevention means is a ring fixed to said outer surface.

11. The system as recited in claim 8 wherein said opening has an outer face and said leakage prevention means is a ring fixed to said outer face.

12. A method for connecting a first piece of plumbing having a glass-filled nylon fitting to a second piece of plumbing comprising:
attaching a connecting member to said second piece of plumbing, said connecting member comprising a hollow body and a flange;
placing a flange nut partially behind said flange, said flange nut having an extension over said flange;
placing said fitting of said first piece of plumbing adjacent said flange; and
a step for attaching said flange nut to said fitting.

13. The method as recited in claim 12 wherein said fitting includes a male threading on its exterior, and said flange nut extension has a female threading, and said step for attaching said flange nut to said fitting comprises screwably engaging said flange nut and said male threaded fitting.

14. The method as recited in claim 12 wherein said fitting includes a fitting flange about the face of said fitting, said fitting flange having at least one opening thereon, and said flange nut extension includes a protrusion extending radially therefrom, said protrusion adapted to fit through said flange opening, wherein said step for attaching said flange nut to said fitting comprises rotatably engaging said protrusion and said fitting.

15. The method as recited in claim 14 wherein said fitting flange comprises at least a pair of interlocking notches at the rear of said fitting flange, and said step for attaching said flange nut to said fitting further comprises locking said protrusion between said notches.

16. The method as recited in claim 12 further comprising placing an O-ring between said flange and said male threaded fitting.

17. The method as recited in claim 12 wherein said flange has an outer surface and said method further comprises affixing a ring to said outer surface of said flange.

18. The method as recited in claim 12 wherein said first piece of plumbing is a valve having a glass-filled nylon body.

19. The method as recited in claim 12 wherein said second piece of plumbing is a pipe.

20. A system for connecting a valve to a pipe comprising:
a glass-filled nylon valve having a glass-filled nylon fitting integrally molded about an opening;
a pipe having an open end;
a connecting member attached to said open end of said pipe, said connecting member having a flange;
an O-ring between said flange and said opening of said valve; and
a flange nut partially behind said flange, said flange nut having an extension over said flange, wherein said flange nut engages said male threaded fitting.

21. The system as recited in claim 20 wherein said fitting includes a male threading on its exterior, and said flange nut extension has a female threading, and said flange nut screwably engages said male threaded fitting.

22. The system as recited in claim 20 wherein said fitting includes a fitting flange about the face of said fitting, said fitting flange having at least one opening thereon, and said flange nut extension includes a protrusion extending radially therefrom, said protrusion adapted to fit through said flange opening, wherein said flange nut rotatably engages said fitting.

23. The system as recited in claim 20 further comprising interlocking notches at the rear of said fitting flange, said notches to lock said protrusion upon rotation of said flange nut.

24. An irrigation valve comprising:
a body;
an inlet port
at least one outlet port wherein the outlet port includes a circumference; and
a male-threaded fitting integrally formed about the circumference of the at least one outlet port.

25. An irrigation valve as claimed in claim 24, wherein the valve and the fitting are made of a resilient material.

26. An irrigation valve as claimed in claim 25, wherein the resilient material is glass-filled nylon.
